(19) United States
(12) Patent Application Publication
(10) Pub. No.: US 2008/0189507 A1
(43) Pub. Date: Aug. 7, 2008

(54) PROGRAM EXECUTION DEVICE AND ELECTRONIC APPARATUS

(75) Inventor: Isao AKIMA, Ogaki (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/024,340

(22) Filed: Feb. 1, 2008

(30) Foreign Application Priority Data
Feb. 2, 2007 (JP) 2007-023823

(51) Int. Cl. G06F 12/02

(52) U.S. Cl. 711/202; 711/E12.002

(57) ABSTRACT

A program execution device includes: a lookup table storage section that stores a lookup table stipulating a plurality of relations between a plurality of input data and a plurality of output data that are results of operation conducted on the plurality of input data; a program storage section that stores a program including a command directing to obtain one of the output data that is a result of the operation conducted on one of the input data, which is defined by the one of the input data and the operation; and a program execution section having a first cycle of designating the one of the input data in the command to the lookup table in the lookup table storage section, and a second cycle of receiving the one of the output data corresponding to the one of the input data from the lookup table.

The entire disclosure of Japanese Patent Application No. 2007-023823, filed Feb. 2, 2007 is expressly incorporated by reference herein.

### BACKGROUND

1. Technical Field

The invention relates to program execution devices having a program execution unit such as a microprocessor (MPU: Micro Processing Unit) and electronic apparatuses including the program execution device.

2. Related Art

A program execution device PE10 in related art includes, as shown in FIG. 8, a MPU 10a having registers reg0 and reg1, a MPU 2a, a ROM 10b that stores a program 10c to be executed by the MPU 10a, a ROM 20b that stores a program 20c to be executed by the MPU 20a, and a RAM 30 that is a work area to execute the programs 10c and 20c.

The RAM 30 stores data at each address, as shown in FIG. 9, and for example, stores data “14” at an address “0000,” and data “32” at an address “0001.”

The program 10c stored in the RAM 10b and the program 20c stored in the RAM 20b each include a command 9, and the command 9 stipulates, for example, that M (0001), i.e., data stored at an address “0001” of the RAM 30, and M (0003), i.e., data stored at an address “0003” of the RAM 30 are to be added, and the result of the addition should be stored at M (M0005), i.e., at an address “0005” of the RAM 30.

An execution of the command 9 in the program 10c by the MPU 10a is composed of four cycles, as shown in FIG. 11, namely, (1) Fetch, (2) Decode, (3) Execution, and (4) Write-back.

(1) In Fetch, as shown in FIG. 11, the MPU 10a transfers data “32” at an address “0001” of the RAM 30 to the register reg0 in the MPU 10a, and also transfers data “54” at an address “0003” of the RAM 30 to the register reg1 in the MPU 10a.

(2) In Decode, the MPU 10a decodes “+” (addition operation).

(3) In Execution, the MPU 10a adds the data “32” in the register reg0 and the data “54” in the register reg1, and temporarily stores the result of addition, data “86,” in the register reg0.

(4) In Write-back, the MPU 10a stores the data “86” in the register reg0 to an address “0005” of the RAM 30.

However, with the program execution device PE10 in related art, the MPU 10a needs four cycles to execute one command 9, as described above, and therefore entails a problem in that it takes a long time to process the command 9.

Further, as shown in FIG. 12, when the MPU 10a executes another command 14 in the program 10c, in other words, when the MPU 10a executes the command 14 stipulating that a result of addition (operation 2) of a result of multiplication (operation 1) of data at an address “0001” and data at an address “0002” and data at an address “0003” should be stored at an address “0004,” and when the operation 1 is to be executed by the MPU 20a with a scheme for executing the operation 1 at high speeds and adjusting the load between the MPU 10a and the MPU 20a, and the operation 2 is to be executed by the MPU 20a, the MPU 10a must wait the execution of the operation 2 until the MPU 20a finishes the execution of the operation 1, as shown in FIG. 13. Therefore there is a problem in that, for execution of the command 14, the execution order of the operation 1 and the operation 2 must be adjusted between the MPU 10a and MPU 20a.

### SUMMARY

In accordance with an embodiment of the present invention, a program execution device includes a lookup table storage section that stores a lookup table stipulating a plurality of relations between a plurality of input data and a plurality of output data that are results of operation conducted on the plurality of input data; a program storage section that stores a program including a command directing to obtain one of the output data that is a result of the operation conducted on one of the input data, which is defined by the one of the input data and the operation; and a program execution section having (1) a first cycle of designating the one of the input data in the command to the lookup table in the lookup table storage section, and (2) a second cycle of receiving the one of the output data corresponding to the one of the input data from the lookup table.

According to the program execution device in accordance with the present embodiment, the program storage section stores the lookup table, such that the program execution section can obtain the one of the output data corresponding to the one of the input data in two cycles, the first cycle and the second cycle. Therefore, the time to process the command can be made shorter, compared to the program execution device in related art that obtains one output data in four cycles.

In the program execution device in accordance with an aspect of the present embodiment, the lookup table storage section may be comprised of a RAM.

According to the program execution device in accordance with the aforementioned aspect of the present embodiment, the lookup table storage section is comprised of a RAM, such that the lookup table can be rewritten, and therefore the lookup table can be updated with time.

In the program execution device in accordance with an aspect of the present embodiment, the RAM may be comprised of a ferroelectric memory.

According to the program execution device in accordance with the aforementioned aspect of the present embodiment, the RAM is comprised of a ferroelectric memory. Therefore, even when an electrical power supply to the ferroelectric memory is interrupted, the ferroelectric memory continues storing the lookup table stored immediately before the interruption, such that updating of the lookup table does not need to be re-done from the beginning, but can be continued from the moment immediately before the interruption.

The program execution device in accordance with an aspect of the present embodiment may have a plurality of the lookup table storage sections, and therefore has a function to perform simultaneous parallel executions of independent operations.

The program execution device in accordance with an aspect of the present embodiment may be equipped with a function of independently, directly inputting table values to be placed in the lookup table storage section, independently of the program execution section, and has a function of optionally, directly rewriting table values in the lookup table storage section.

The program execution device in accordance with an aspect of the present embodiment may be equipped with a function of independently operating and inputting table values to be placed in the lookup table storage section, independently of the program execution section, and has a function of optionally, directly rewriting table values in the lookup table storage section with operation resultant values.

An electronic apparatus in accordance with an embodiment of the invention includes the program execution device described above.

### BRIEF DESCRIPTION OF THE DRAWINGS

FIG. 1 is a schematic diagram of the structure of a program execution device in accordance with Embodiment Example 1 of the invention.

FIG. 2 is a figure showing contents of a lookup table in accordance with Embodiment Example 1.

FIGS. 3A and 3B are figures showing operations of the program execution device in accordance with Embodiment Example 1.

FIG. 4 is a schematic diagram of the structure of a program execution device in accordance with Embodiment Example 2.

FIG. 5 is a figure showing changes of lookup tables in accordance with Embodiment Example 2.

FIG. 6 is a schematic diagram of the structure of a program execution device in accordance with Embodiment Example 3.

FIG. 7 is a figure showing renewal of a lookup table in accordance with Embodiment Example 3.

FIG. 8 is a schematic diagram of the structure of a program execution device in related art.

FIG. 9 is a figure showing contents of a RAM in related art.

FIG. 10 is a figure showing contents of a program in related art.

FIG. 11 is a figure showing cycles of executing the program in related art.

FIG. 12 is a figure showing contents of another program in related art.

FIG. 13 is a figure showing execution of the other program in related art.

### DESCRIPTION OF EXEMPLARY EMBODIMENTS

Program execution devices in accordance with preferred embodiments of the invention are described below with reference to the accompanying drawings.

### Embodiment Example 1

Structure

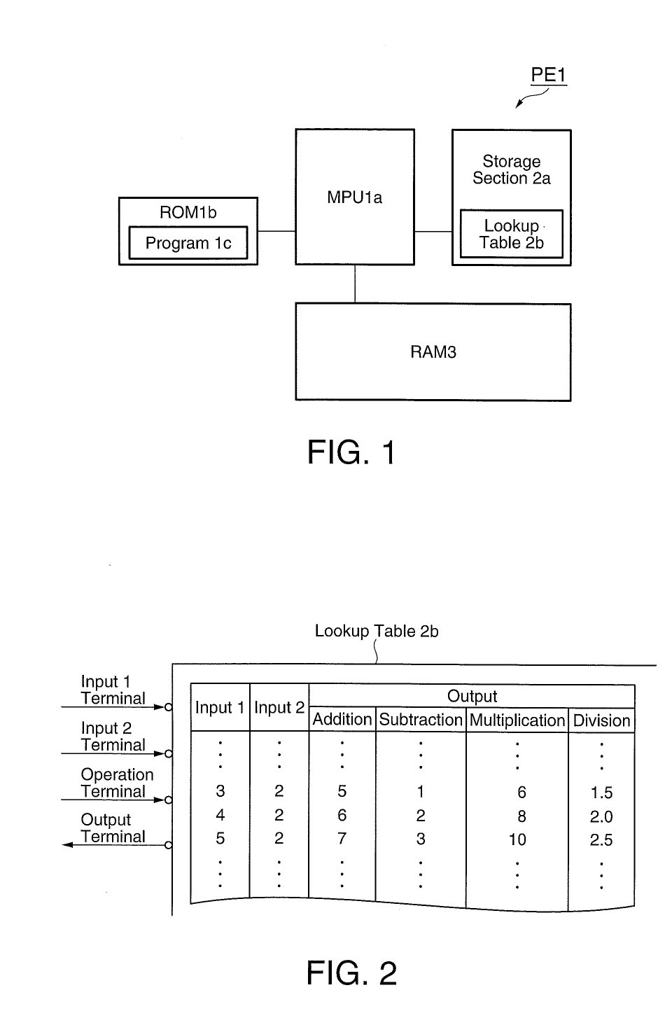

FIG. 1 shows the structure of a program execution device PE1 in accordance with Embodiment Example 1. The program execution device PE1 includes a MPU 1a, a ROM 1b, a storage section 2a and a RAM 3, as shown in FIG. 1.

The MPU 1a is a “program execution section,” and executes a program 1c stored in the ROM 1b.

The ROM 1b is a “program storage section,” and stores a program 1c including a command 9 and a command 14 to be executed by the MPU 1a, like the ROM 10b of related art shown in FIG. 10 and FIG. 12.

The storage section 2a is a “lookup table storage section,” and stores a lookup table 1b to be referred to by the MPU 1a when executing the program 1c. As shown in FIG. 2, the lookup table 2b has an input 1 terminal that receives a designation of input data as “input 1,” an input terminal 2 that receives a designation of input data as “input 2,” an operation terminal that receives a designation of the kind of “operation” (addition, subtraction, multiplication, or division), and an output terminal that externally provides output data as an output that is a result obtained by conducting the “operation” on input data designated as the “input 1 ” and input data designated as the “input 2.”

Upon receiving designations of input data and the kind of operation at the input 1 terminal, the input terminal 2 and the operation terminal of the lookup table 2b, respectively, the storage section 2a outputs output data specified by the input data and the kind of operation on the lookup table 2b from the output terminal (first cycle). When the output data appears at the output terminal of the lookup table 2b, the MPU 1a writes the output data to the RAM 3 (second cycle).

The RAM 3 is a work area where the MPU 1a executes the program 1c, and is used for storing data at each address, like the RAM 30 in related art shown in FIG. 9. More specifically, the RAM 3 is used for storing the input data and the output data after the operation.

Operation

Operations of the program execution device in accordance with Embodiment Example 1 are described. For easier explanation and understanding, it is assumed that the RAM 3 stores data at each address shown in FIG. 9, and the MPU 1a executes the command 9 shown in FIG. 10.

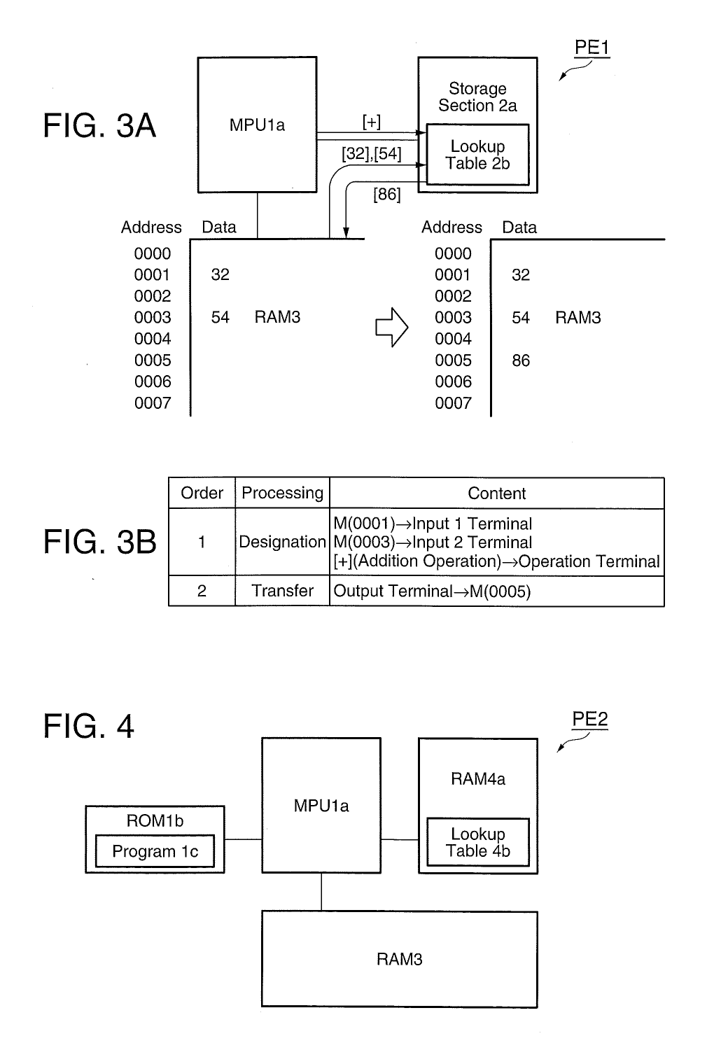

The first cycle: According to the command 9 in the program 10c, in other words, for “M (0001)+M (0003)→M (0005),” the MPU 1a designates data “32” stored at the address “0001” of the RAM 3 to the input 1 terminal of the lookup table 2b, designates data “54” stored at the address “0003” of the RAM 3 to the input terminal 2 of the lookup table 2b, and designates an addition operation “+” to the operation terminal of the lookup table 2b, as shown in FIGS. 3A and 3B. When “32 is designated to the input 1 terminal, “54” is designated to the input terminal 2, and the “+” is designated to the operation terminal, the lookup table 2b outputs a result of addition “86” to the output terminal, as shown in FIG. 3A.

Second cycle: As shown in FIGS. 3A and 3B, the MPU 1a transfers the result of addition “86” outputted at the output terminal of the lookup table 2b to an address “0005,” and writes the result of addition “86” to the address “0005.”

Effects

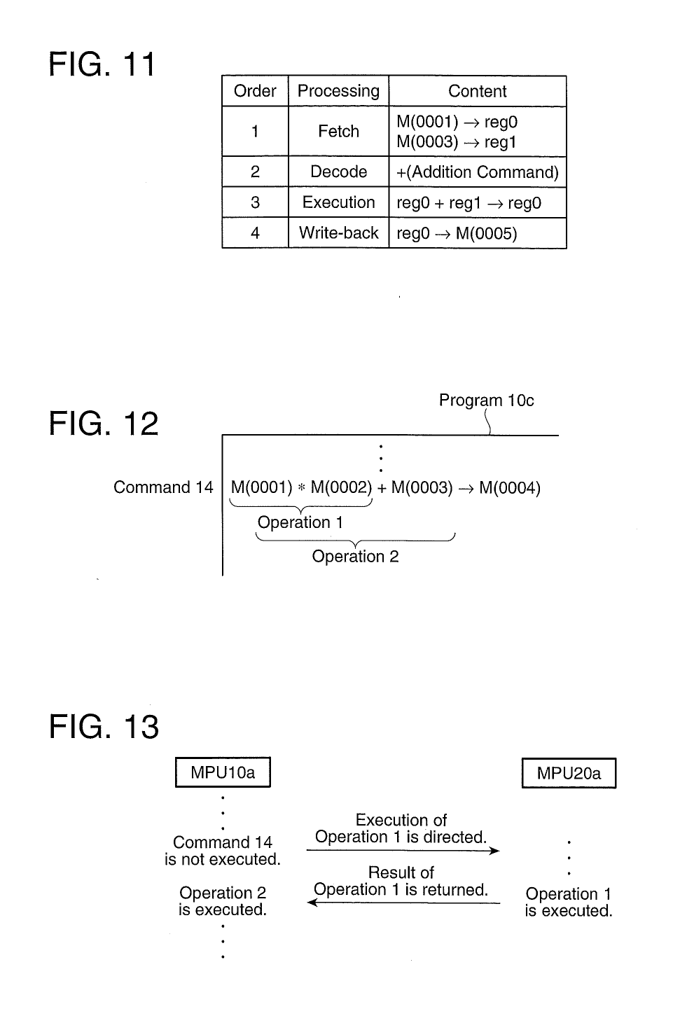

As described above, according to the program execution device PE1 of Embodiment Example 1, the storage section 2a stores the lookup table 2b that stipulates relations between inputs 1, inputs 2, operations, and outputs that are results of the operations rendered on the inputs 1 and inputs 2, and the MPU 1a executes the command 9 that includes one of the inputs 1, one of the inputs 2 and one of the operations through referring to the lookup table 2b, whereby the execution of the command 9 is completed in two cycles. Accordingly, the time for processing the command 9 can be shortened, compared to the program execution device PE10 of related art, as shown in FIG. 11, which completes the execution of a command 9 in four cycles.

According to the program execution device PE1 of Embodiment Example 1, only the MPU 1a alone executes the program 1c, and it is not required for two MPUs 10a and 20a to work together to execute one program 10c, like the related art, whereby complexities, such as, adjustment of the order of executions of operation between the two MPUs 10a and 20a can be avoided.

### Embodiment Example 2

Structure

FIG. 4 shows the structure of a program execution device PE2 in accordance with Embodiment Example 2. It is clear from the comparison between the program execution device PE1 of Embodiment Example 1 shown in FIG. 1 and the program execution device PE2 of Embodiment Example 2 shown in FIG. 4 that the program execution device PE2 in accordance with Embodiment Example 2 includes a MPU 1a, a ROM 1b, a program 1c and a RAM 3, like the program execution device PE1 of Embodiment Example 1, and on the other hand includes a RAM 4a that is a rewritable memory and a lookup table 4b, instead of the storage section 2a and the lookup table 2b, for processing (for example, rendering correction of saturation and luminosity on), for example, images of a changing object to be photographed (for example, scenes and person), which is different from the program execution device PE1 of Embodiment Example 1.

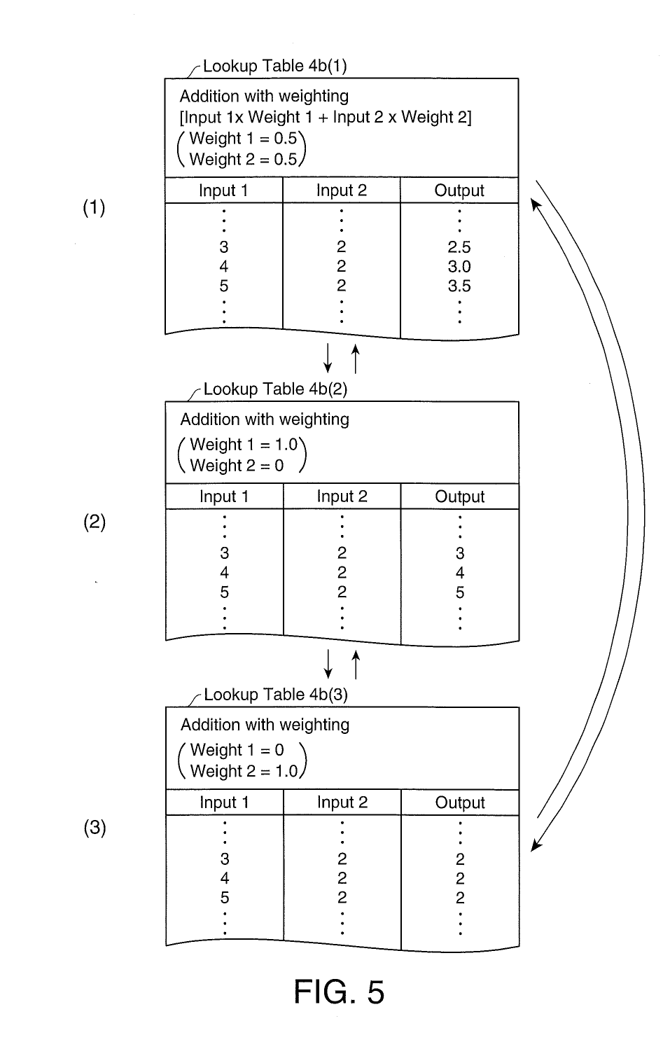

In order to change the contents of processing to be rendered on the photographed image according to the contents of the change in the object, in other words, in order to change the result to be obtained by executing the command 9, the lookup table 4b stored in the RAM 4a is changed to a lookup table 4b (1), a lookup table 4b (2) and a lookup table 4B (3) in an arbitrary order or in a regular order (for example, cyclically), which have mutually different contents (“weight” values to be described below), as indicated in FIG. 5.

The lookup tables 4b (1), 4b (2) and 4b (3) each stipulate an “addition with weighting” in which a result of input 1 weighted by a weight 1 and a result of input 2 weighted by a weight 2 are added, more correctly, stipulate relations between inputs 1, inputs 2, a weight 1, a weight 2 and outputs that are results of addition. The lookup tables 4b (1), 4b (2) and 4b (3) have mutually different values in the weight 1 and the weight 2. The weight 1 and the weight 2 are 0.5 and 0.5 in the lookup table 4b (1), 1.0 and 0 in the lookup table 4b (b), and 0 and 1.0 in the lookup table 4b (3).

Operation

Operations of the program execution device in accordance with Embodiment Example 2 are described. For easier explanation and understanding, it is assumed that the MPU 1a executes a command 32 (not shown) that specifies an addition “3+2” through referring to the lookup table 4b.

In the program execution device PE2 in accordance with Embodiment Example 2, the RAM 4a initially stores, for example, a lookup table 4b (1) with a weight 1=0.5 and a weight 2=0.5, as the lookup table 4b, as shown in FIG. 5 (1). The MPU 1a executes the command 32 through referring to the lookup table 4b (1), and renders its execution result “2.5,” as a processing content to be rendered on the object, on an image of the object.

Then, the MPU 1a changes the weight 1 from 0.5 to 1.0, and the weight 2 from 0.5 to 0 according to the change in the object, as indicated in FIG. 5 (2), thereby changing the lookup table 4b (1) to the lookup table 4b (2), then executes the command 32 through referring to the lookup table 4b (2) in a similar manner as described above, and renders its execution result “3” on the image of the object.

Further, the MPU 1a changes the weight 1 from 1.0 to 0, and the weight 2 from 0 to 1.0 according to the change in the object, as indicated in FIG. 5 (3), thereby changing the lookup table 4b (2) to the lookup table 4b (3), then executes the command 32 through referring to the lookup table 4b (3) in a similar manner as described above, and renders its execution result “2” on the image of the object.

Effect

As described above, in the program execution device PE2 in accordance with Embodiment Example 2, the lookup table 4b is sequentially changed from the lookup table 4b (1), to the lookup table 4b (2) and to the lookup table 4b (3), in other words, the lookup table 4b is updated, according to changes in the object that is photographed, such that the execution result of the command 32, which is the content of a processing to be rendered on the image of the object, can be changed according to changes in the object.

### Embodiment Example 3

Structure

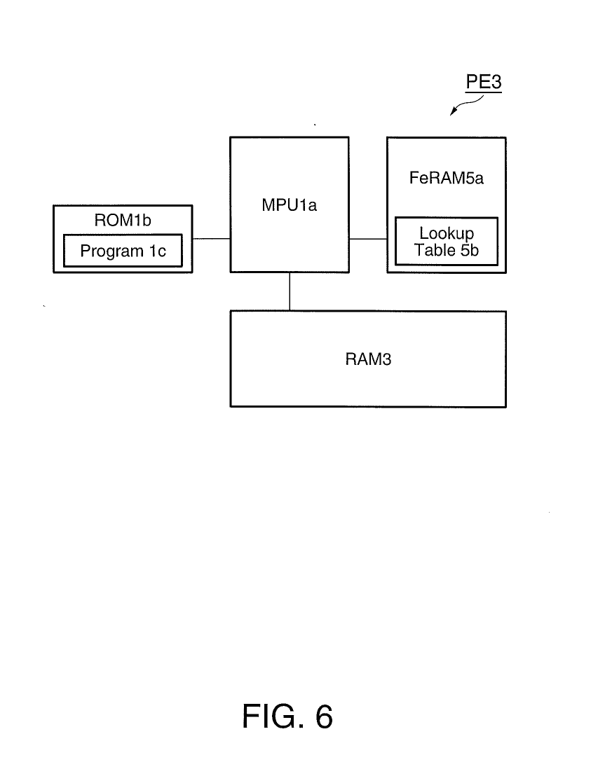

FIG. 6 shows the structure of a program execution device PE3 in accordance with Embodiment Example 3. As shown in FIG. 6, the program execution device PE3 in accordance with Embodiment Example 3 includes a MPU 1a, a ROM 1b, a program 1c and a RAM 3, like the program execution devices PE1 and PE2 of Embodiment Example 1 and Embodiment Example 2, and on the other hand includes a FeRAM 5a that is a ferroelectric memory having nonvolatility and a lookup table 5b, instead of the storage section 2a and the lookup table 2b, and the RAM 4a and the lookup table 4b, which are different from the program execution devices PE1 and PE2 of Embodiment Example 1 and Embodiment Example 2.

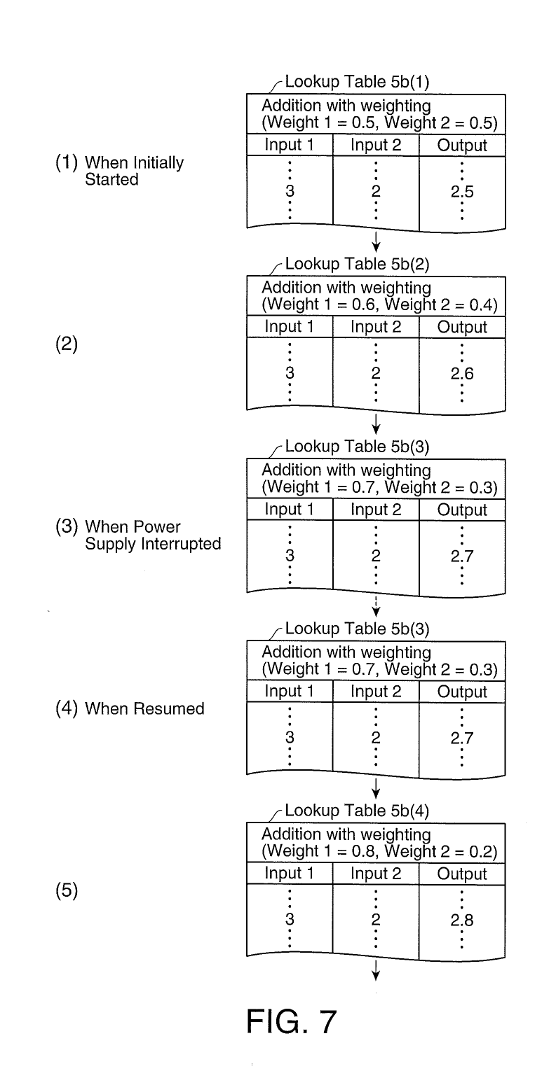

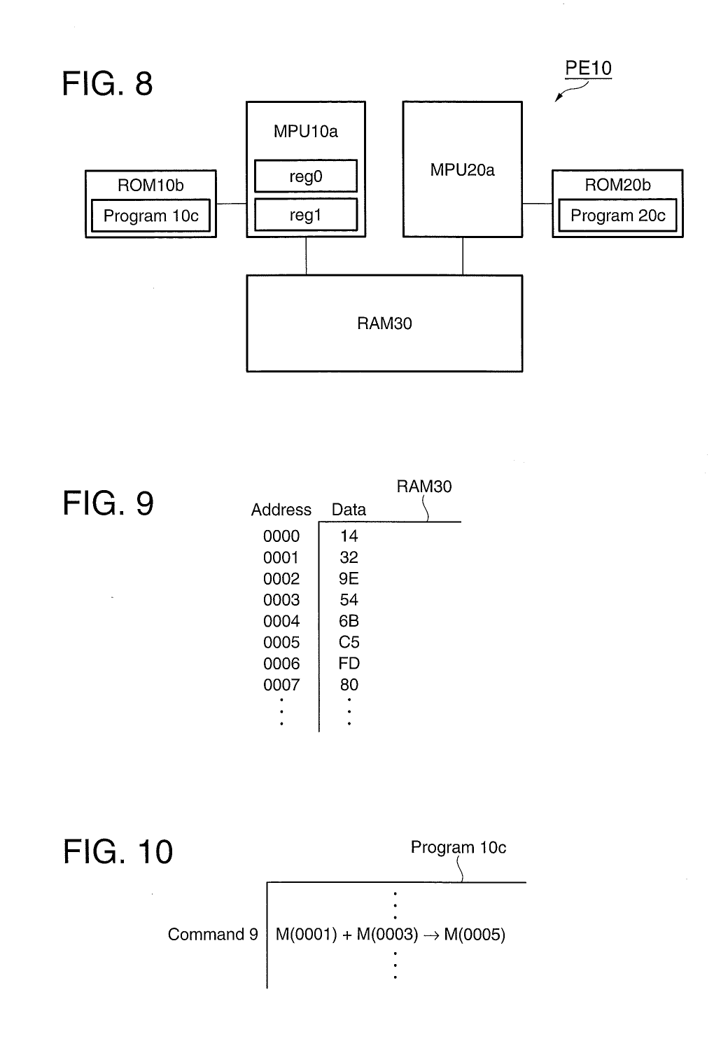

The lookup table 5b stored in the FeRAM 5a stipulates, as shown in FIG. 7, an “addition with weighting” similar to that of the lookup table 4b of Embodiment Example 2, and is sequentially changed from a lookup table 5b (1), to a lookup table 5b (2), to a lookup table 5b (3), to a lookup table 5b (4), . . . , etc., according to changes in the object that is photographed. By this, the MPU 1b would change its execution result of a command, which is the content of a processing to be rendered on the image of the object, even with the same command, like Embodiment Example 2.

Operation

Operations of the program execution device in accordance with Embodiment Example 3 are described. For easier explanation and understanding, it is assumed that the MPU 1a executes a command 32 (not shown) that specifies an addition “3+2” through referring to the lookup table 4b, like Embodiment Example 2.

In the program execution device PE3 in accordance with Embodiment Example 3, the FeRAM 5a initially stores a lookup table 5b (1) with a weight 1=0.5 and a weight 2=0.5, as the lookup table 5b, as shown in FIG. 7 (1). The MPU 1a executes the command 32 through referring to the lookup table 5b (1), and renders its execution result “2.5” on an image of the object.

Then, the MPU 1a changes the weight 1 from 0.5 to 0.6, and the weight 2 from 0.5 to 0.4 according to the change in the object, as indicated in FIG. 7 (2), thereby changing the lookup table 5b (1) to the lookup table 5b (2), then executes the command 32 through referring to the lookup table 5b (2), and renders its execution result “2.6” on the image of the object.

Then, the MPU 1a changes the lookup table 5b (2) to the lookup table 5b (3) according to the change in the object, as indicated in FIG. 7 (3), then executes the command 32 through referring to the lookup table 5b (3), and renders its execution result “2.7” on the image of the object.

If the power supply (electrical power supply) to the program execution device PE3 is unexpectedly interrupted at the time when the execution of the command 32 is completed through referring to the lookup table 5b (3), the FeRAM 5a with nonvolatility would continue storing the lookup table 5b (3) that is stored immediately before the interruption of the power supply. As a result, as indicated in FIG. 7 (4), at the time of restart, in other words, when the power supply is restored, the MPU 1a can execute the command 32 through referring to the lookup table 5b (3) stored immediately before the power supply interruption, but not through referring to the initial lookup table 5b (1).

Furthermore, the MPU 1a can make an update, based on the lookup table 5b (3) at the time of restart, and according to a later change in the object to be photographed, to a lookup table 5b (4).

Also, by preparing a plurality of lookup tables, an appropriate one of the lookup tables can be freely selected according to changes in an object, such that multiple references may be made at once, and multiple operations may be simultaneously processed.

Effect

As described above, in the program execution device PE3 in accordance with Embodiment Example 3, the lookup table 5b to be referred to when the MPU 1a executes the command 32 is stored in the FeRAM 5a having nonvolatility. Therefore, even when the power supply to the program execution device PE3 is unexpectedly interrupted, whereby the power supply to the FeRAM 5a is shut off, the lookup table 5b (3) stored immediately before the interruption of the power supply continues to be stored. Accordingly, when the power supply is restored at the time of restart, the MPU 1a can execute the program 1c through referring to the lookup table 5b (3) in which updates by rewriting have progressed, but not through going back to the initial state and referring to the initial lookup table 5b (1), and may further quickly update the lookup table 5b to the lookup table 5b (4) according to the lookup table 5b (3) and a later change in the object. Also, multiple references to the lookup tables may be combined for making an update, and such multiple references may be simultaneously executed, whereby different plural similar effects can be obtained.

### Embodiment Example 4

An electronic apparatus that includes a program execution device in accordance with an embodiment of the invention is described. Embodiment examples of the electronic apparatus include one of the program execution devices PE1-PE3 in accordance with Embodiment Examples 1-3, and may be, for example, computers, cellular phones, digital cameras, digital TV apparatuses, automobiles, robots, and controller apparatuses. In the electronic apparatus, the MPU 1a described above executes commands in a program 1c that stipulate processings (for example, data processing, communication processing and image processing) to be performed by the electronic apparatus, in a similar manner as described above, through referring to the lookup table 2b stored in the storage section 2a, the lookup table 4b stored in the RAM 4a or the lookup table 5b stored in the FeRAM 5a, whereby effects similar to those described above can be obtained.

What is claimed is:

1. A program execution device comprising:
a lookup table storage section that stores a lookup table stipulating a plurality of relations between a plurality of input data and a plurality of output data that are results of operation conducted on the plurality of input data;
a program storage section that stores a program including a command directing to obtain one of the output data that is a result of the operation conducted on one of the input data, which is defined by the one of the input data and the operation; and
a program execution section having a first cycle of designating the one of the input data in the command to the lookup table in the lookup table storage section, and a second cycle of receiving the one of the output data corresponding to the one of the input data from the lookup table.

2. A program execution device according to claim 1, wherein the lookup table storage section is comprised of a RAM.

3. A program execution device according to claim 2, wherein the RAM is comprised of a ferroelectric memory.

4. A program execution device according to claim 1, comprising a plurality of the lookup table storage sections, thereby having a function to perform simultaneous parallel executions of independent operations.

5. A program execution device according to claim 1, comprising a function of independently, directly inputting table values to be placed in the lookup table storage section, independently of the program execution section, and a function of optionally, directly rewriting table values in the lookup table storage section.

6. A program execution device according to claim 1, comprising a function of independently operating and inputting table values to be placed in the lookup table storage section, independently of the program execution section, and has a function of optionally, directly rewriting table values in the lookup table storage section with operation resultant values.

7. An electronic apparatus comprising the program execution device recited in claim 1.
